(19) United States
(12) Patent Application Publication
(10) Pub. No.: US 2015/0186129 A1
(43) Pub. Date: Jul. 2, 2015

(54) METHOD AND SYSTEM FOR DEPLOYING A PROGRAM MODULE

(71) Applicant: International Business Machines Corporation, Armonk, NY (US)

(72) Inventors: Ajay A. Apte, AUSTIN, TX (US); Yang Che, Beijing (CN); Tan Jiang, Beijing (CN); Orvalle T. Kirby, III, Raleigh, NC (US); Da Hu Kuang, Beijing (CN); Ling Lan, Beijing (CN); Lin Sun, Morrisville, NC (US); Liang Wang, Beijing (CN); Yong Yao, Beijing (CN); Li Yi, Beijing (CN); Yu Zhang, Beijing (CN)

(21) Appl. No.: 14/591,312

(22) Filed: Jan. 7, 2015

(30) Foreign Application Priority Data
Jan. 2, 2014 (CN) 201410001101.0

(51) Int. Cl. G06F 9/445; G06F 9/455

(52) U.S. Cl. CPC G06F 8/65; G06F 9/44505; G06F 9/45533

(57) ABSTRACT

Embodiments of the invention relate to deploying a program module. The deploying includes obtaining a data dependency relationship between the program module and multiple to-be-deployed program modules, and a specific start order. In response to a request to install and configure the program module, data on which the program module depends are identified according to the data dependency relationship. In addition, the program module is installed and configured responsive to the identified data. The program module is started in response to completion of a startup of program modules required to be started before the program module as specified by the specific start order.

### FOREIGN PRIORITY

This application claims priority to Chinese Patent Application No. 201410001101.0, filed Jan. 2, 2014 and all benefits accruing therefrom under 35 U.S.C. §119, the contents of which in its entirety are herein incorporated by reference.

### BACKGROUND

The present disclosure relates generally to computer software, and more specifically, to deploying a software module.

PaaS (Platform-as-a-Service) is a business model that provides a server platform as a service. In a cloud computing environment, providing a cloud computing server platform or development environment to users as a service results in PaaS.

FIG. 4 schematically depicts a cloud computing platform 400, where the cloud computing is a PaaS platform. A PaaS provider provides cloud computing platform 400 as shown in FIG. 4. With such a PaaS platform, a client (not shown in FIG. 4) can send a request to cloud computing platform 400, to request, for example, the installation of a software environment for four software modules to serve customers, namely program module A, program module B, program module C, and program module D. Upon receiving this request, cloud computing platform 400 creates virtual machines (e.g., virtual machine 1 and virtual machine 2) via a network 401 according to available resources in the existing platform, and then installs the above requested program modules on virtual machine 1 and virtual machine 2. Later, the client can directly connect to virtual machine 1 and virtual machine 2 via network 401 to use software resources installed on virtual machine 1 and virtual machine 2.

The process where the cloud computing platform 400 (after creating the virtual machines) installs, configures, and starts the required program modules on the virtual machines is the process of deploying a program module.

### SUMMARY

Embodiments include a method, system, and computer program product for deploying a program module. The deploying includes obtaining a data dependency relationship between the program module and multiple to-be-deployed program modules, and a specific start order. In response to a request to install and configure the program module, data on which the program module depends are identified according to the data dependency relationship. In addition, the program module is installed and configured responsive to the identified data. The program module is started in response to completion of a startup of program modules required to be started before the program module as specified by the specific start order.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a cloud computing node in accordance with an embodiment;

FIG. 2 depicts a cloud computing environment in accordance with an embodiment;

FIG. 3 depicts abstraction model layers in accordance with an embodiment;

FIG. 4 schematically depicts an exemplary cloud computing platform;

FIG. 5 depicts an exemplary data dependency relationship relating to three virtual machines VM0-VM3 and three to-be-installed program modules;

FIG. 6 depicts an exemplary start order among program modules in the example of FIG. 5;

FIG. 7 schematically depicts a flowchart of a method for deploying a program module in accordance with an embodiment;

FIG. 8 depicts a schematic graphical user interface used for editing a data dependency relationship among multiple to-be-deployed program modules in accordance with an embodiment;

FIG. 9 depicts a profile shown in graphics of a data dependency relationship and specific start order among multiple to-be-deployed program modules in accordance with an embodiment; and

FIG. 10 depicts a block structural diagram of a system for deploying a program module in accordance with an embodiment.

### DETAILED DESCRIPTION

Embodiments are directed to deploying multiple program modules having data dependency and start ordering requirements. Embodiments provide an automatic deployment process that can control a dependency relationship among modules and a start order. This can lead to reducing the workload of service program development for application developers.

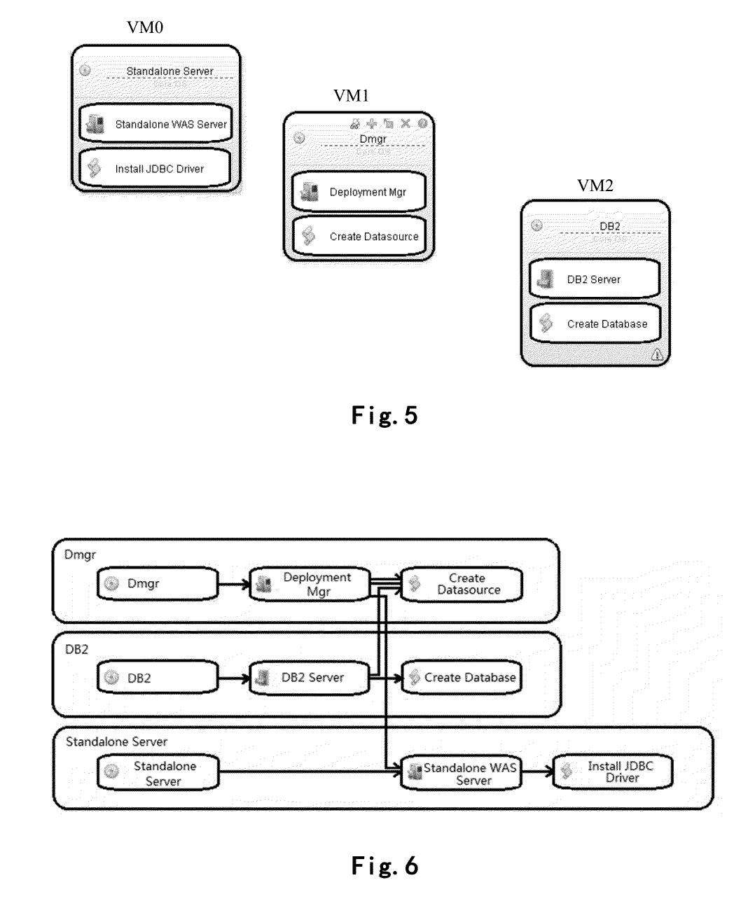

As described previously, the process where a cloud computing platform, such as cloud computing platform 400 in FIG. 4, installs, configures and starts program modules on previously created virtual machines is referred to herein as “deploying program modules.” In the process of virtual machine deployment by a cloud computing platform, data dependencies can exist among program modules. For example, FIG. 5 depicts a data dependency relationship among three to-be-installed program modules in three virtual machines VM0, VM1, and VM2. A Deployment Manager (Mgr) (or other server management) program module and a Create Datasource (create data source) program module can be deployed on a virtual machine that is responsible for managing a plurality of Standalone Web Application Server (WAS) (or other application server) nodes and performing a data source connection function for the plurality of Standalone WAS Server nodes, the function being accomplished by the Create Datasource (create data source) program module. According to these requirements, three virtual machines VM0, VM1 and VM2 can be created. Virtual machine VM0 can be a standalone server on which a Standalone WAS Server program module and a Java Database Connectivity (JDBC) Driver program module will be installed; virtual machine VM1 a management server on which a Deployment Manager program module and a Create Datasource program module will be installed; and virtual machine VM2 a database server on which a DB2 program module and a Create Database program module will be installed.

In an embodiment, the Standalone WAS Server program module needs the IP address, port, cell name, registry protocol type, etc. from the Deployment Manager program module, so that the Standalone WAS Server program module can register itself to the Deployment Manager program module. In addition, the Create Datasource program module in VM1 needs the JDBC entry point from the DB2 Server program module, so that the Create Datasource program module can set up the connection to the database. That is, the Standalone WAS Server and the Deployment Manager have a data dependency relationship between them; and the Create Datasource and the DB2 Server have a data dependency relationship between them.

After the installation of these program modules is completed, a specific start order is needed to ensure the success of the whole service deployment. FIG. 6 depicts a start order of program modules in the example shown in FIG. 5. In this example, the Create Datasource program module needs to modify some datasource configuration information of the Deployment Manager program module, so the Create Datasource program module needs to be started after the Deployment Manager program module and also needs the installation path and other information of the server management node. That is, according to data dependencies, the Create Datasource program module can only be started after the Deployment Manager program module and the DB2 Server program module are started; and the Create Datasource program module can only be started after the DB2 Server program module is started. Only after the Deployment Manager program module is started, the Standalone WAS Server program module can be started and in turn the Install JDBC Driver program module can be started.

In contemporary systems, these data dependencies and start orders require the cloud service provider to develop specific code logic for implementing data dependencies and start orders. This compounds the complexity of programmer development efforts and can lead to an increased workload for programmers.

Exemplary embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

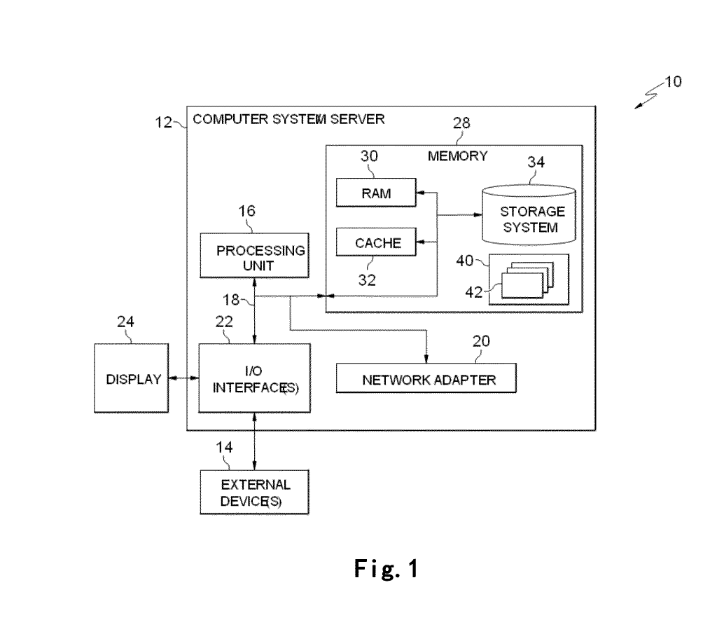

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

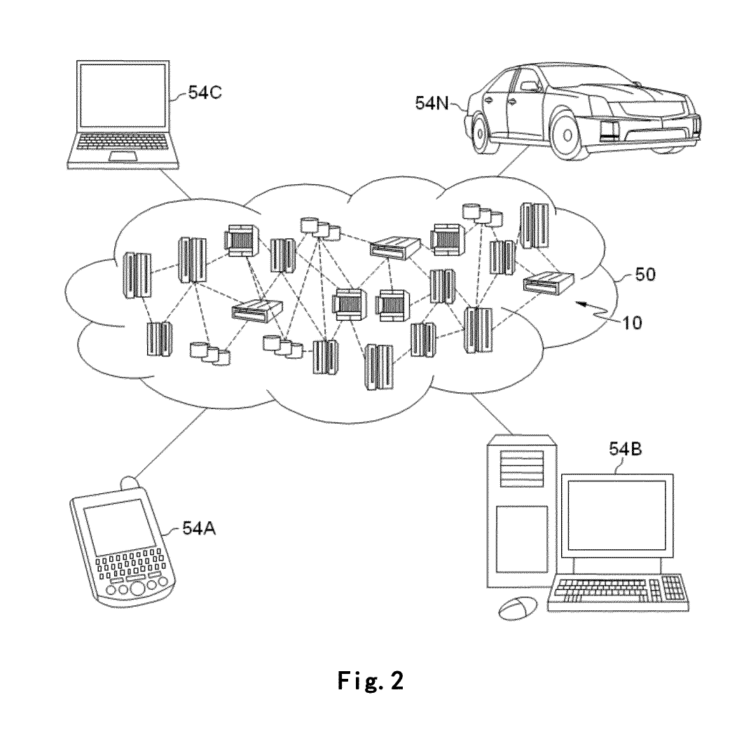

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

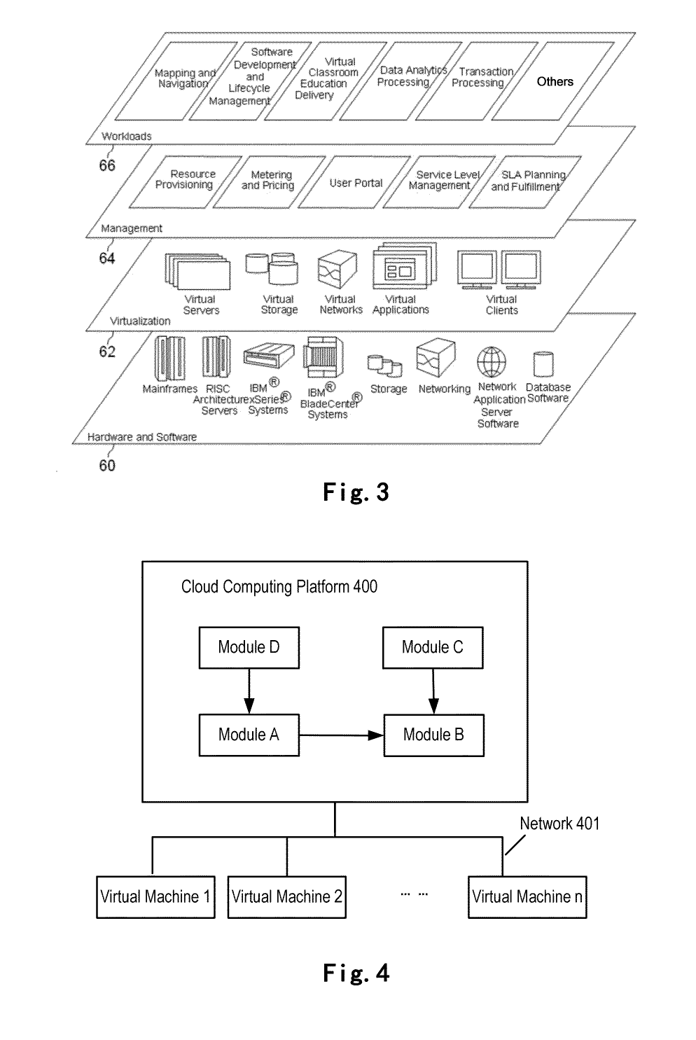

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

In embodiments, the cloud computing platform can develop a method for deploying a program module on a management layer, i.e., layer 64 in FIG. 3. After at least one virtual machine is created, software implementing the method is installed in the created at least one virtual machine; the method for deploying a program module is executed in at least one virtual machine that is created in response to a request in the cloud computing platform, and the at least one virtual machine deploys a plurality of program modules required by the request. Through the coordination among these virtual machines, the deployment of a user-requested service is completed. Here, the deploying a program module comprises installation, parameter configuration and start of the program module.

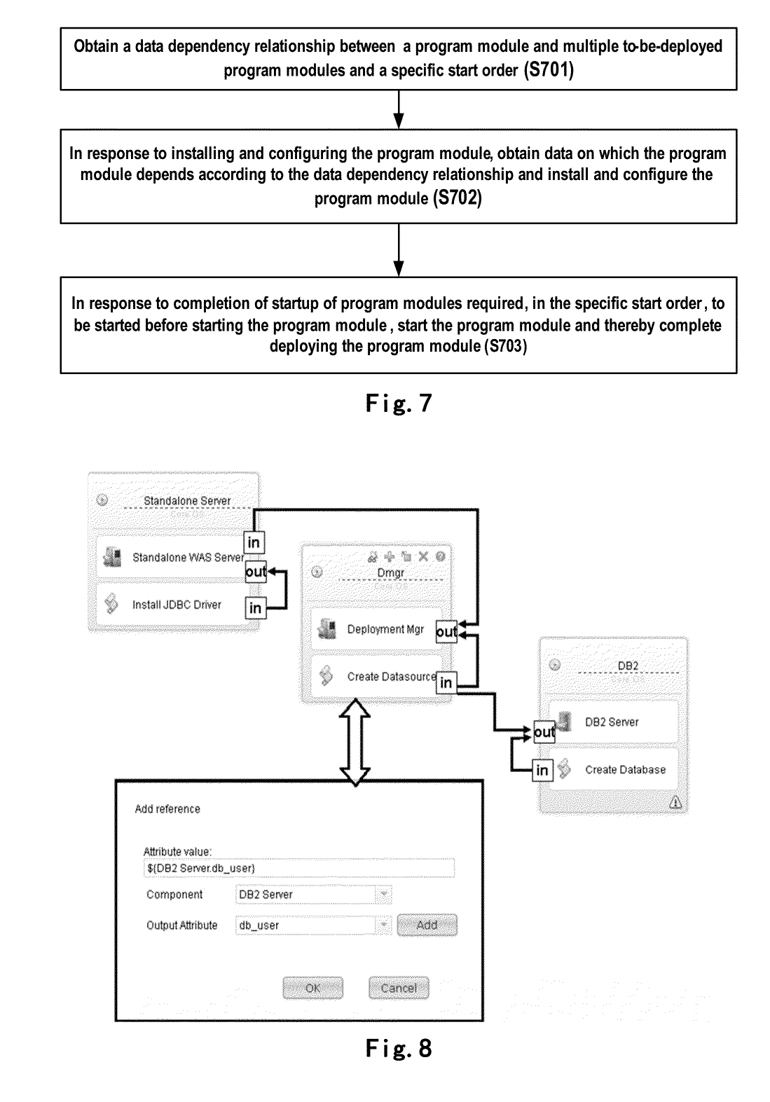

According to an embodiment of the present invention, there is disclosed a method for deploying a program module, the method being executed in runtime by virtual machines that are created in the cloud computing platform. FIG. 7 depicts a flowchart of a method for deploying a program module according to one embodiment of the present invention. According to FIG. 7, the method includes: at block S701, obtaining a data dependency relationship between the program module and multiple to-be-deployed program modules and a specific start order; at block S702, in response to installing and on figuring the program module, obtaining data on which the program module depends according to the data dependency relationship and installing and configuring the program module; and at block S703, starting the program module in response to completion of startup of program modules required, in the specific start order, to be started before starting the program module. In this manner, the deployment of the program module is completed.

For example, referring back to FIG. 5 which depicts three virtual machines and six program modules, each virtual machine can execute the above method whereby the deployment of all program modules is completed, and then users can use these program modules.

In an embodiment, a data dependency relationship among multiple to-be-deployed program modules and a specific start order may be described by using editor editing. In an embodiment, a graphical user interface may be provided to the user, and then the user describes a data dependency relationship among multiple to-be-deployed program modules and a specific start order by dragging. The data dependency relationship among multiple to-be-deployed program modules and the specific start order presented by the user via the graphical user interface can be transformed into text, script language or other specified form. FIG. 8 depicts a schematic graphical user interface for editing a data dependency relationship among multiple to-be-deployed program modules, where a program module labeled with “in” depends on data in a program module labeled with “out,” and an arrow connection represents a dependency between them. Before startup of the Create Datasource program module, datasource IP, port and other information is needed, and the information is outputted by the DB2 Server (or other data server) program module; thereby, the relationship here is defined as a dependency relationship, i.e., a source module (e.g., the Create Datasource) depends on information outputted by another destination module (e.g., the DB2 Server), and only after the source module obtains the dependent information from the object module, can it be executed.

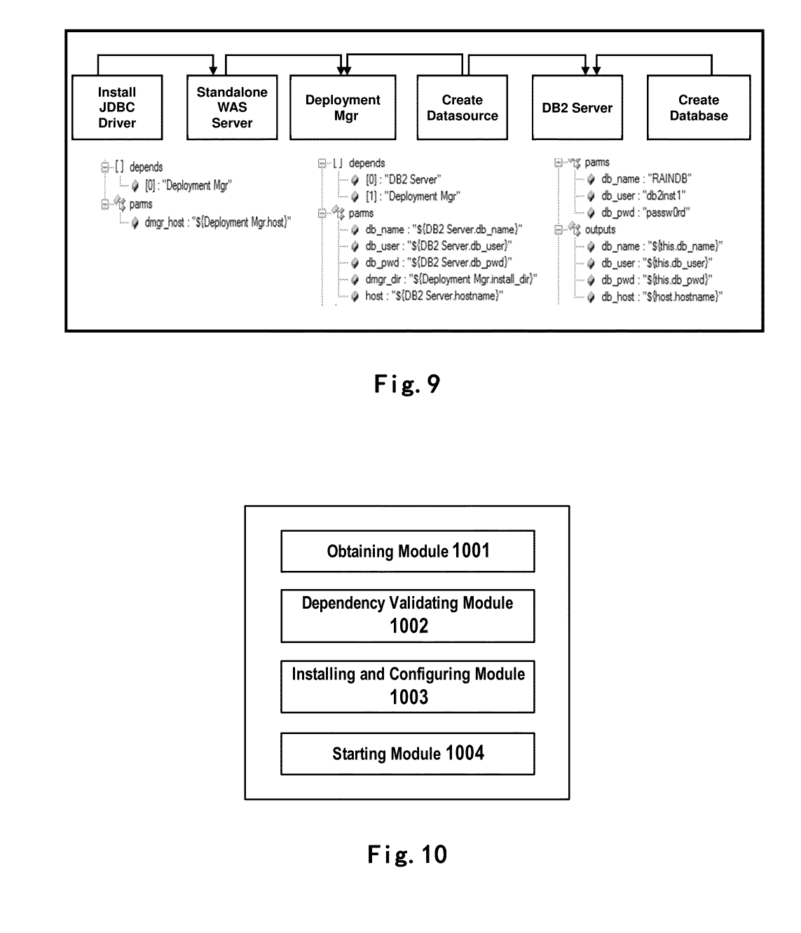

In another example, the Standalone WAS Server program module depends on the Deployment Manager program module and needs to import from the Deployment Mgr program module data such as IP Address, port, cell name, registry protocol type and so on. By double-clicking on the arrow in shown FIG. 8, the user can state an attribute value of to-be-imported data in a dialogue box and edit the attribute value of the imported data. In the meanwhile, with respect to a specific program module, the user may also state a specific attribute of the program module, which is not detailed here. For the graphical user interface shown in FIG. 8, a profile shown in graphics of a data dependency relationship among multiple to-be-deployed program modules and a specific start order may be generated as shown in FIG. 9.

In addition, the profile of a data dependency relationship among multiple to-be-deployed program modules and specific start order may also be described using text or script language or any other form that is known to those skilled in the art. Different description rules may be formulated so as to facilitate delivery. Those skilled in the art should understand that either using a graphical user interface for editing or using a graphical profile for description is for the purpose of convenient use; in fact, a text editor may be used to directly edit text or script file of the data dependency relationship among multiple to-be-deployed program modules and the specific start order.

By taking the Create DataSource program module and the DB2 Server program modules as examples, illustration is presented below regarding using script language to describe a data dependency relationship and specific start order between these two program modules.

The dependency and start order for the Create DataSource program module can be as described in an embodiment as:

″Create DataSource″: {

″depends″: [

″DB2 Server″,
″Deployment Mgr″],

// the Create DataSource program module depends on the
Deployment Mgr

program module and the DB2 Server program module

″parms″: {

// Parms defines all attribute values of the Create DataSource program
module, i.e., the
Create DataSource program module depends on the following information
of the DB2
Server program module: DB2 Server.hostname (server name), DB2
Server.db_name
(database name), DB2 Server.db_user (user name) and DB2
Server.db_pwd (password)
of DB2 Server. The Create DataSource program module depends on
Deployment
Mgr.install_dir (installation directory) of the Deployment Mgr program
module.

″db_name″: ″DB2 Server.db_name″,
″db_user″: ″DB2 Server.db_user″,
″db_pwd″: “DB2 Server.db_pwd”,
″host″: ″DB2 Server.hostname″
″dmgr_dir″: ″Deployment Mgr.install_dir″,

}

}.

It should be noted that if there exists only a sequence start relationship (e.g., A is started after B) but no data dependency relationship between program module A and program module B, then module B will be placed in the dependency list of A; in the parameter Parms, however, there is no definition, i.e., no data dependency between A and B. This relationship may be simply described as:

“A” : {

“depends” :[“B”]

}

For a program module being depended on, such as the DB2 Server program module, its script may be defined as:

“DB2 Server”: {

“parms”: {

“db_name”: “RAINDB”,
“db_user”: “db2inst1”,
“db_pwd”: “passw0rd”

},
“outputs”: [ “db_name”, “db_user”, “db_pwd”, “db_host”]
}

As shown above, “parms” represents parameter set values of the data server module itself, such as database name, user password, etc. Also as shown above, “outputs” represents a list of parameters to be outputted by the data server module, the outputted parameter values will be depended on and used by the Create Datasource program module.

The data dependency relationship between the program module and multiple to-be-deployed program modules and the specific start order may, after creating a virtual machine, be directly loaded to the created virtual machine by the cloud computing platform. In an embodiment, each virtual machine stores the data dependency relationship among multiple program modules which are required to be deployed by the request and the specific start order; in another embodiment, the cloud computing platform may split the data dependency relationship among multiple program modules which are required to be deployed by the request and the specific start order, and load to the corresponding created virtual machine only the part, related to the program module, of the data dependency relationship among multiple program modules which are required to be deployed by the request and the specific start order. In another embodiment, the cloud computing platform may still split the data dependency relationship among multiple program modules which are required to be deployed by the request and the specific start order, and load to the corresponding created virtual machine only the part, related to a virtual machine where the program module is located, of the data dependency relationship among multiple program modules which are required to be deployed by the request and the specific start order.

Next, the virtual machine installs and configures the program module. This can include the virtual machine obtaining data on which the program module depends according to any type of the data dependency relationship loaded to the cloud computing platform, of the above data dependency relationship in the data dependency relationship between the program module and multiple to-be-deployed program modules and the specific start order. If what is loaded to the virtual machine is the data dependency relationship among multiple program modules which are required to be deployed by the request and the specific start order, the virtual machine first separates data related to a program module installed inside itself from the above data and then installs and configures each program module one by one. If other program modules are to be installed and configured on one virtual machine, then according to the data dependency relationship and the specific start order, an analysis is made as to which one among the program module and other program module will provide dependent data, and a program module providing the dependent data is installed and configured as a priority.

There exist different embodiments of obtaining data on which the program module depends according to the data dependency relationship. In one embodiment, the virtual machine sends a monitoring message to a virtual machine where the depended program module is located according to the data dependency relationship, and checks attribute values of data described in the dependency relationship. Messages can be sent all the while until a result is obtained; or messages are sent periodically until a result is obtained. That is, the virtual machine can execute the following operations (not shown in FIG. 7): according to the data dependency relationship, checking a virtual machine where a program module on which the program module depends is located; sending a request for obtaining data on which the program module depends to the virtual machine where the program module being depended on is located; and receiving and storing the data on which the program module depends.

In another embodiment, the virtual machine does not send a check message to a virtual machine where the program module being depended on is located, but waits for the virtual machine where the program module being depended on is located to send attribute values of data described in the dependency relationship and receives the attribute values. That is, the virtual machine executes the following operations (not shown in FIG. 7): receiving data, wherein it is identified the data are related to dependent data; judging whether the received data are data on which the program module depends, according to the data dependency relationship between the program module and multiple to-be-deployed program modules; and in response to the received data being data on which the program module depends, storing the data on which the program module depends.

After obtaining the dependent data, the virtual machine can install and configure the program module, at which point it is considered starting the program module. If the specific start order among the program module and multiple to-be-deployed program modules requires that other program modules be started before starting the program module, then only after other program module is started can the program module be started, thereby the deployment of the program module is completed. As to whether other program module has been started, there also exist various embodiments just like the above-described embodiments for obtaining data on which the program module depends according to the data dependency relationship.

In one embodiment, the virtual machine may query a virtual machine where the other program module is located. This can include executing the following steps: according to the specific start order, obtaining a virtual machine where a program module required to be started before starting the program module is located; sending a message checking whether a program module required to be started before starting the program module has been started to the virtual machine where the program module required to be started before starting the program module is located; receiving a response from the virtual machine where the program module required to be started before starting the program module is located; and according to the received response, determining whether startup of the program module required to be started before starting the program module has been completed.

In another embodiment, the virtual machine may wait for a virtual machine where other program module is located to report to the virtual machine. This can include executing the following steps: receiving data, wherein it is identified the data are related to an execution order; and according to the specific start order, judging whether the receive data are data indicating whether the startup of the program module required to be started before starting the program module has been completed.

If a plurality of program modules are required to be started before starting the program module, as specified by the specific start order, then the virtual machine further needs to monitor or judge one by one whether each of these program modules have been started. If each virtual machine finds, by analysis according to a data dependency relationship between multiple program modules deployed on itself and multiple program modules to be deployed and a specific start order, that the virtual machine needs to provide dependent data or start execution order message, then the virtual machine reacts as required by the above embodiments.

The various embodiments implementing embodiments of the present invention have been described above with reference to the accompanying drawings. Those skilled in the art may understand that the method may be implemented in software, hardware or a combination of software and hardware. Moreover, those skilled in the art may understand by implementing various steps in the above method in software, hardware or a combination of software and hardware, there may be provided a system for deploying a program module based on the same inventive concept. Even if the system has the same hardware structure as a general-purpose processing device, the functionality of software contained therein makes the system manifest distinguishing properties from the general-purpose processing device, thereby forming an apparatus of the various embodiments of the present invention. The apparatus described in embodiments of the present invention comprises several units or modules, the units or modules configured to execute corresponding steps. Upon reading this specification, those skilled in the art may understand how to write a program for implementing actions performed by the units or modules. Since the system is based on the same inventive concept as the method, the same or corresponding implementation details are also applicable to an apparatus corresponding to the method. As detailed and complete description has been presented above, the apparatus is not detailed below.

According to an embodiment of the present invention, there is disclosed a system for deploying a program module. FIG. 10 schematically depicts a block structural diagram of the system. According to FIG. 10, the system comprises: an obtaining module 1001 configured to obtain a data dependency relationship between the program module and multiple to-be-deployed program modules and a specific start order; a dependency validating module 1002 configured to, in response to installing and configuring the program module, obtain data on which the program module depends according to the data dependency relationship; an installing and configuring module 1003 configured to install and configure the program module; and a starting module 1004 configured to start the program module in response to the completion of startup of program modules required, in the specific start order, to be started before starting the program module.

Embodiments described herein include a method, system, and computer program product for deploying a program module. A method can include: obtaining a data dependency relationship between the program module and multiple to-be-deployed program modules and a specific start order; in response to installing and configuring the program module, obtaining data on which the program module depends according to the data dependency relationship and installing and configuring the program module; and starting the program module in response to completion of startup of the program modules required, in the specific start order, to be started before starting the program module. Embodiments can be used to reduce the workload of service program development for application developers.

In one embodiment, the system for deploying a program module is executed in at least one virtual machine that is created in a cloud computing platform in response to a request, wherein the at least one virtual machine deploys multiple program modules required by the request. Further, the at least one virtual machine obtains from the cloud computing platform a program module to be deployed in the virtual machine and the data dependency relationship and the specific start order.

In another embodiment, the data dependency relationship and the specific start order comprise at least one of: a data dependency relationship among multiple to-be-deployed program modules required by the request and a specific start order; a part, related to the program module, in the data dependency relationship among multiple to-be-deployed program modules required by the request and specific start order; and a part, related to a virtual machine where the program module is located, in the data dependency relationship among multiple to-be-deployed program modules required by the request and the specific start order.

In an embodiment, the system further includes: a prioritizing module configured to, in response to another program module further needing to be installed and configured in one virtual machine, analyze which of the program module and other program module will provide depended data according to the data dependency relationship and the specific start order, and prioritize to install and configure a program module providing the dependent data.

In an embodiment, the dependency validating module includes: a dependency virtual machine obtaining module configured to check a virtual machine where a program module on which the program module depends is located according to the data dependency relationship; a dependency data requesting module configured to send a request for obtaining data on which the program module depends to the virtual machine where the program module being depended on is located; and a dependency data receiving module configured to receive and store the data on which the program module depends.

In an embodiment, the dependency validating module includes: a dependency-related data receiving module configured to receive data, wherein the data are identified to be related to the dependent data; a dependency validating module configured to judge whether the received data are data on which the program module depends, according to the data dependency relationship; and a dependency storing module configured to, in response to the received data being data on which the program module depends, store the data on which the program module depends.

In another embodiment, the starting module 1004 includes: a related virtual machine obtaining module configured to obtain a virtual machine where a program module required to be started before starting the program module is located, according to the specific start order; a start checking module configured to send a message for checking whether a program module required to be started before starting the program module has been started, to the virtual machine where the program module required to be started before starting the program module is located; a start receiving module configured to receive a response of the virtual machine where the program module required to be started before starting the program module is located; and a start determining module configured to determine whether the startup of the program module required to be started before starting the program module has been completed, according to the received response.

In an embodiment, the starting module 1004 comprises: a start-related data receiving module configured to receive data, wherein the data are identified to be related to an execution order; and a start check-related data receiving module configured to judge whether the received data are data indicating whether the startup of the program module required to be started before starting the program module has been completed, according to the specific start order.

In another embodiment, the starting module 1004 is further configured to: in response to multiple program modules required to be started before starting the program module existing in the specific start order, judge one by one whether each of the multiple program modules have been started.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for deploying a program module, comprising:
obtaining a data dependency relationship between the program module and multiple to-be-deployed program modules, and a specific start order;
in response to a request to install and configure the program module, identifying data on which the program module depends according to the data dependency relationship, and installing and configuring the program module responsive to the identified data; and
starting the program module in response to completion of a startup of program modules required to be started before the program module as specified by the specific start order.

2. The method according to claim 1, wherein the identifying, installing, configuring and starting are executed by at least one virtual machine that is created in a cloud computing platform in response to the request, wherein the at least one virtual machine deploys multiple program modules required by the request.

3. The method according to claim 2, wherein the at least one virtual machine obtains from the cloud computing platform the program module to be deployed in the virtual machine as well as the data dependency relationship between the program module and the multiple to-be-deployed program modules and the specific start order.

4. The method according to claim 1, wherein the data dependency relationship between the program module and the multiple to-be-deployed program modules, and the specific start order comprises at least one of:
a data dependency relationship among the multiple to-be-deployed program modules required by the request and the specific start order;
a part, related to the program module, in the data dependency relationship among the multiple to-be-deployed program modules required by the request and the specific start order; and
a part, related to the virtual machine where the program module is located, in the data dependency relationship among the multiple to-be-deployed program modules required by the request and the specific start order.

5. The method according to claim 1, wherein the method further comprises, in response to an other program module needing to be installed and configured in a virtual machine, analyzing which of the program module and the program modules provide dependent data to the other program according to the data dependency relationship and the specific start order, and determining when to install and configure the other program module based on the analyzing.

6. The method according to claim 1, wherein the identifying data on which the program module depends according to the data dependency relationship comprises:
checking a virtual machine where an other program module on which the program module depends is located according to the data dependency relationship;
sending a request for obtaining data on which the program module depends to the virtual machine where the other program module being depended on is located; and
receiving and storing the data on which the program module depends.

7. The method according to claim 1, wherein the identifying data on which the program module depends according to the data dependency relationship comprises:
receiving data, wherein the data are identified to be related to the data on which the program module depends;
determining whether the received data are data on which the program module depends, the determining based on the data dependency relationship; and
in response to the received data being data on which the program module depends, storing the data on which the program module depends.

8. The method according to claim 1, further comprising:
obtaining a virtual machine where the program modules required to be started before starting the program module as specified by the specific start order are located;
sending a message, to check whether the program modules required to be started before starting the program module have been started, to the virtual machine where the program modules required to be started before starting the program module are located;
receiving a response from the virtual machine where the program modules required to be started before starting the program module are located; and
determining whether the startup of the program modules required to be started before starting the program module has been completed, according to the received response.

9. The method according to claim 1, further comprising:
receiving data, wherein the data are identified to be related to an execution order; and
determining whether the received data are data indicating whether the startup of the program modules required to be started before starting the program module have been completed, according to the specific start order.

10. The method according to claim 1, further comprising:
in response to multiple program modules required, in the specific start order, to be started before starting the program module, determining one by one whether the startup of each of the multiple program modules required to be started before starting the program module has been completed.

11. A system for deploying a program module, comprising:
a memory having computer readable instructions; and
a processor for executing the computer readable instructions, the computer readable instructions including:
obtaining a data dependency relationship between the program module and multiple to-be-deployed program modules, and a specific start order;
in response to a request to install and configure the program module, identifying data on which the program module depends according to the data dependency relationship, and installing and configuring the program module responsive to the identified data; and
starting the program module in response to completion of a startup of program modules required to be started before the program module as specified by the specific start order.

12. The system according to claim 11, wherein the identifying, installing, configuring and starting are executed by at least one virtual machine that is created in a cloud computing platform in response to the request, wherein the at least one virtual machine deploys multiple program modules required by the request.

13. The system according to claim 11, wherein the data dependency relationship between the program module and the multiple to-be-deployed program modules and the specific start order comprises at least one of:
a data dependency relationship among the multiple to-be-deployed program modules required by the request and the specific start order;
a part, related to the program module, in the data dependency relationship among the multiple to-be-deployed program modules required by the request and the specific start order; and
a part, related to the virtual machine where the program module is located, in the data dependency relationship among the multiple to-be-deployed program modules required by the request and the specific start order.

14. The system according to claim 13, wherein the at least one virtual machine obtains from the cloud computing platform the program module to be deployed in the virtual machine as well as the data dependency relationship between the program module and the multiple to-be-deployed program modules, and the specific start order.

15. The system according to claim 14, wherein the method further comprises, in response to an other program module needing to be installed and configured in a virtual machine, analyzing which of the program module and the program modules provide dependent data to the other program according to the data dependency relationship and the specific start order, and determining when to install and configure the other program module based on the analyzing.

16. The system according to claim 11, wherein the identifying data on which the program module depends according to the data dependency relationship comprises:
checking a virtual machine where an other program module on which the program module depends is located according to the data dependency relationship;
sending a request for obtaining data on which the program module depends to the virtual machine where the other program module being depended on is located; and
receiving and storing the data on which the program module depends.

17. The system according to claim 11, wherein the identifying data on which the program module depends according to the data dependency relationship comprises:
checking a virtual machine where an other program module on which the program module depends is located according to the data dependency relationship;
sending a request for obtaining data on which the program module depends to the virtual machine where the other program module being depended on is located; and
receiving and storing the data on which the program module depends.

18. The system according to claim 11, wherein the method further comprises:
obtaining a virtual machine where the program modules required to be started before starting the program module as specified by the specific start order are located;
sending a message, to check whether the program modules required to be started before starting the program module have been started, to the virtual machine where the program modules required to be started before starting the program module are located;
receiving a response from the virtual machine where the program modules required to be started before starting the program module are located; and
determining whether the startup of the program modules required to be started before starting the program module has been completed, according to the received response.

19. The system according to claim 11, wherein the method further comprises:
receiving data, wherein the data are identified to be related to an execution order; and
determining whether the received data are data indicating whether the startup of the program modules required to be started before starting the program module have been completed, according to the specific start order.

20. A computer program product for deploying a program module, the computer program product comprising:
a computer readable storage medium having program code embodied therewith, the program code is executable by a processor for:
obtaining a data dependency relationship between the program module and multiple to-be-deployed program modules, and a specific start order;
in response to a request to install and configure the program module, identifying data on which the program module depends according to the data dependency relationship, and installing and configuring the program module responsive to the identified data; and
starting the program module in response to completion of a startup of program modules required to be started before the program module as specified by the specific start order.
